(19) United States
(12) Patent Application Publication
(10) Pub. No.: US 2011/0063348 A1
(43) Pub. Date: Mar. 17, 2011

(54) Liquid Ejection Head, Methods of Manufacturing and Driving the Same, and Image Recording Apparatus

(76) Inventor: Tsuyoshi Mita, Ashigarakami-gun (JP)

(21) Appl. No.: 12/881,109

(22) Filed: Sep. 13, 2010

(30) Foreign Application Priority Data
Sep. 14, 2009 (JP) 2009212161

(51) Int. Cl. B41J 29/38; B41J 2/045; B23P 17/00

(52) U.S. Cl. 347/9; 347/68; 29/890.1

(57) ABSTRACT

A liquid ejection head includes a piezoelectric actuator that changes volume of a pressure chamber to cause liquid in the pressure chamber to eject from a nozzle connected with the pressure chamber, wherein the piezoelectric actuator is formed into a projecting shape protruding toward the pressure chamber, and displaced in a direction opposite to the pressure chamber when applied with a driving voltage, to increase the volume of the pressure chamber.

### BACKGROUND OF THE INVENTION

1. Field of the Invention

The present invention relates to a liquid ejection head, methods of manufacturing and driving the same, and an image recording apparatus, and particularly, relates to a liquid ejection head, methods of manufacturing and driving the same, and an image recording apparatus capable of obtaining high generated pressure.

2. Description of the Related Art

It is known that, in a piezoelectric liquid ejection head, an individual electrode of a piezoelectric actuator is formed into a circle along a rim part of a pressure chamber. Japanese Patent Application Publication No. 2006-150948 discloses a liquid ejection head that uses such a circular individual electrode and improves the displacement efficiency by forming a piezoelectric body in the area other than the region corresponding to the central section of a pressure chamber.

Japanese Patent Application Publication No. 2004-42329, on the other hand, discloses a liquid ejection head that uses a general individual electrode that is not in a circular form. In the liquid ejection head, a diaphragm is previously deflected into a projecting shape protruding toward a pressure chamber so that sufficient displacement can be obtained even when the diaphragm is formed into a thin film, and the diaphragm is displaced to the pressure chamber side to eject liquid.

Japanese Patent Application Publication No. 2000-141643 and International Publication No. WO 01/072521 each disclose a liquid ejection head that uses a general individual electrode that is not in a circular form. In the liquid ejection head, a diaphragm is previously deflected into a projecting shape protruding toward the side opposite to a pressure chamber so that sufficient displacement can be obtained even when the diaphragm is formed into a thin film, and the diaphragm is displaced to the pressure chamber side to eject liquid.

Japanese Patent No. 4287278 discloses a liquid ejection head in which a piezoelectric body is disposed on top of, and in contact with, a diaphragm that is deflected into a projecting shape protruding toward the side opposite to a pressure chamber, an individual electrode and common electrode are disposed on this piezoelectric body, a driving voltage is applied between the individual electrode and the common electrode to displace the diaphragm to the pressure chamber side, and thereby liquid droplets are ejected.

However, a disadvantage of the liquid ejection head that is configured as described in Japanese Patent Application Publication No. 2006-150948 is that the rigidity thereof decreases as a result of forming the piezoelectric body without including the area corresponding to the central section of the pressure chamber, and, for example, highly viscous liquid might not be ejected.

A disadvantage of the liquid ejection head that is configured as described in Japanese Patent Application Publication No. 2004-42329 is that a high displacement cannot be ensured because the diaphragm is further displaced in a deflected direction.

A disadvantage of the liquid ejection heads that are configured as described in Japanese Patent Application Publication No. 2000-141643 and International Publication No. WO 01/072521 is that a high displacement cannot be obtained because the diaphragm is displaced from the state where it is deflected into a projecting shape protruding toward the side opposite to the pressure chamber, to the state where it is brought back to a neutral point with no deflection. Another disadvantage of the liquid ejection heads described in Japanese Patent Application Publication No. 2000-141643 and International Publication No. WO 01/072521 is that it is difficult to control the thickness of the diaphragm and therefore its thickness fluctuation because the diaphragms of these liquid ejection heads are formed by means of a film formation.

A disadvantage of the liquid ejection head that is configured as described in Japanese Patent No. 4287278 is that high voltage is required to drive this liquid ejection head in order to obtain a significant displacement due to the special electrode configuration.

### SUMMARY OF THE INVENTION

The present invention has been contrived in view of such circumstances, and an object thereof is to provide a liquid ejection head including a piezoelectric actuator that has a highly rigid and produces high displacement, methods of manufacturing and driving such a liquid ejection head, and an image recording apparatus.

In order to attain an object described above, one aspect of the present invention is directed to a liquid ejection head comprising a piezoelectric actuator that changes volume of a pressure chamber to cause liquid in the pressure chamber to eject from a nozzle connected with the pressure chamber, wherein the piezoelectric actuator is formed into a projecting shape protruding toward the pressure chamber, and displaced in a direction opposite to the pressure chamber when applied with a driving voltage, to increase the volume of the pressure chamber.

According to this aspect of the invention, the piezoelectric actuator is formed into a projecting shape protruding toward the pressure chamber and displaced in a direction opposite to the pressure chamber when the driving voltage is applied.

Desirably, the piezoelectric actuator passes beyond a neutral point with no deflection and deforms into a projecting shape protruding toward the direction opposite to the pressure chamber, when applied with the driving voltage.

According to this aspect of the invention, when the driving voltage is applied, the piezoelectric actuator passes beyond the neutral point with no deflection and deforms into a projecting shape protruding toward the side opposite to the pressure chamber. As a result, a high displacement amount can be obtained.

Desirably, the piezoelectric actuator includes: a diaphragm which forms a wall surface of the pressure chamber; a piezoelectric body which is disposed on a surface of the diaphragm opposite from the pressure chamber; an individual electrode which is disposed on one surface of the piezoelectric body and in a region where the individual electrode overlaps with a rim part of the pressure chamber; and a common electrode which is disposed on another surface of the piezoelectric body.

According to this aspect of the invention, the individual electrode is disposed in the form of a circle in a region where the individual electrode overlaps with the rim part of the pressure chamber. In the piezoelectric actuator having the individual electrode formed into a circle, a tensile stress is generated by applying the driving voltage. Therefore, the displacement can be increased.

Desirably, the piezoelectric actuator is formed into the projecting shape protruding toward the pressure chamber by forming the piezoelectric body on the diaphragm having a coefficient of linear expansion lower than that of the piezoelectric body, according to a thin film forming method involving a heat treatment.

According to this aspect of the invention, the piezoelectric actuator is formed into a projecting shape protruding toward the pressure chamber by forming the piezoelectric body on the diaphragm having a coefficient of linear expansion lower than that of the piezoelectric body, by means of a thin film forming method involving a heat treatment. In this manner, the piezoelectric actuator that is bent into a projecting shape protruding toward the pressure chamber can be obtained easily.

Desirably, the piezoelectric body contains Nb, and a coefficient of linear expansion of the piezoelectric body is made higher than that of the diaphragm by adjusting an additive amount of the Nb contained in the piezoelectric body.

According to this aspect of the invention, the additive amount of Nb is adjusted and the coefficient of linear expansion of the piezoelectric body is thereby made higher than the coefficient of linear expansion of the diaphragm. As a result, the coefficient of linear expansion of the piezoelectric body can be adjusted easily, and a desired piezoelectric actuator can readily be configured.

Desirably, the diaphragm is made of silicon.

According to this aspect of the invention, the diaphragm is made of silicon with a low coefficient of linear expansion.

Desirably, the pressure chamber is formed in a silicon substrate.

Desirably, the pressure chamber and the nozzle are provided in plurality, respectively, in such a manner that the pressure chambers are arrayed in a staggered manner in a substrate, and the nozzles are arrayed in a staggered manner in a nozzle surface.

According to this aspect of the invention, the pressure chambers are arrayed in a staggered manner and the nozzles are arrayed in a staggered manner on the nozzle surface. In other words, the pressure chambers and the nozzles are arrayed two-dimensionally in a first direction, as well as in a second direction that is inclined at a predetermined angle to the first direction. Accordingly, the density of the nozzles can be increased.

Desirably, the liquid ejection head further comprises a control device which controls application of the driving voltage to the piezoelectric actuator so as to adjust ejection of a liquid droplet from the nozzle in such a manner that the driving voltage is applied to the piezoelectric actuator only when the liquid droplet is ejected from the nozzle.

According to this aspect of the invention, the driving voltage is applied to the piezoelectric actuator only when a liquid droplet is ejected from the nozzle. Therefore, the liquid ejection head can be driven highly reliably.

Desirably, the piezoelectric body is polarized in terms of a thickness direction of the piezoelectric body, and contracts in a direction perpendicular to the thickness direction when the driving voltage is applied to the piezoelectric body.

Desirably, the individual electrode has an outer circumference corresponding to an outer circumference of the piezoelectric body, and has an inner circumference similar to the outer circumference of the individual electrode.

In order to attain an object described above, another aspect of the present invention is directed to a method of manufacturing a liquid ejection head comprising a piezoelectric body disposed on a diaphragm forming a wall surface of a pressure chamber, the method comprising the step of forming the piezoelectric body on the diaphragm having a coefficient of linear expansion lower than that of the piezoelectric body, according to a thin film forming method involving a heat treatment, in such a manner that the piezoelectric body and the diaphragm are bent into a projecting shape protruding toward the pressure chamber.

According to this aspect of the invention, the piezoelectric body is formed on the diaphragm having a coefficient of linear expansion lower than that of the piezoelectric body, by means of a thin film forming method involving a heat treatment. By this means, the piezoelectric actuator that is bent into a projecting shape protruding toward the pressure chamber can be obtained easily.

Desirably, the method of manufacturing a liquid ejection head further comprises the step of forming an individual electrode in a region where the individual electrode overlaps with a rim part of the pressure chamber.

According to this aspect of the invention, the individual electrode is disposed in the form of a circle in a region where the individual electrode overlaps with the rim part of the pressure chamber. According to the piezoelectric actuator having the individual electrode formed into a circle, a tensile stress is generated by applying the driving voltage. Therefore, a piezoelectric actuator that produces high displacement can be configured.

Desirably, the diaphragm is made of silicon.

According to this aspect of the invention, the diaphragm is made of silicon with a low coefficient of linear expansion.

Desirably, the pressure chamber is formed in a silicon substrate.

Desirably, an additive of Nb is adjusted to control the coefficient of linear expansion of the piezoelectric body.

According to this aspect of the invention, the additive amount of Nb is adjusted and the coefficient of linear expansion of the piezoelectric body is thereby made higher than the coefficient of linear expansion of the diaphragm.

Desirably, the piezoelectric body is polarized in terms of a thickness direction of the piezoelectric body, and contracts in a direction perpendicular to the thickness direction when a driving voltage is applied to the piezoelectric body.

Desirably, the individual electrode has an outer circumference corresponding to an outer circumference of the piezoelectric body, and has an inner circumference similar to the outer circumference of the individual electrode.

In order to attain an object described above, another aspect of the present invention is directed to an image recording apparatus comprising any of the liquid ejection heads defined above.

According to this aspect of the invention, image recording is carried out by using any of the liquid ejection heads described above.

In order to attain an object described above, another aspect of the present invention is directed to a method of driving any of the liquid ejection heads defined above, comprising the step of applying a driving voltage to the piezoelectric actuator only when a liquid droplet is ejected from the nozzle.

According to this aspect of the invention, the driving voltage is applied to the piezoelectric actuator only when a liquid droplet is ejected from the nozzle. Therefore, the liquid ejection head can be driven highly reliably.

According to the present invention, a highly rigid piezoelectric actuator that produces high displacement can be obtained.

### BRIEF DESCRIPTION OF THE DRAWINGS

FIG. 1 is a diagram showing the entire configuration of an inkjet recording apparatus;

FIG. 2 is a plane perspective view of an ink ejection surface of an inkjet head;

FIG. 3 is a vertical cross-sectional diagram showing a part of an inkjet head;

FIG. 4 is a plan view of a piezoelectric actuator;

FIGS. 5A and 5B are explanatory diagrams illustrating operations of a piezoelectric actuator; and

FIG. 6 is a diagram showing an example of a drive waveform of driving voltage applied to a piezoelectric actuator.

### DESCRIPTION OF THE PREFERRED EMBODIMENTS

Hereinafter, preferred embodiments of the present invention are described with reference to the accompanying drawings.

Note that an example in which the present invention is applied to an inkjet head is described herein. First of all, a configuration of an inkjet head recording apparatus using such an inkjet head is described.

### Configuration of an Inkjet Recording Apparatus

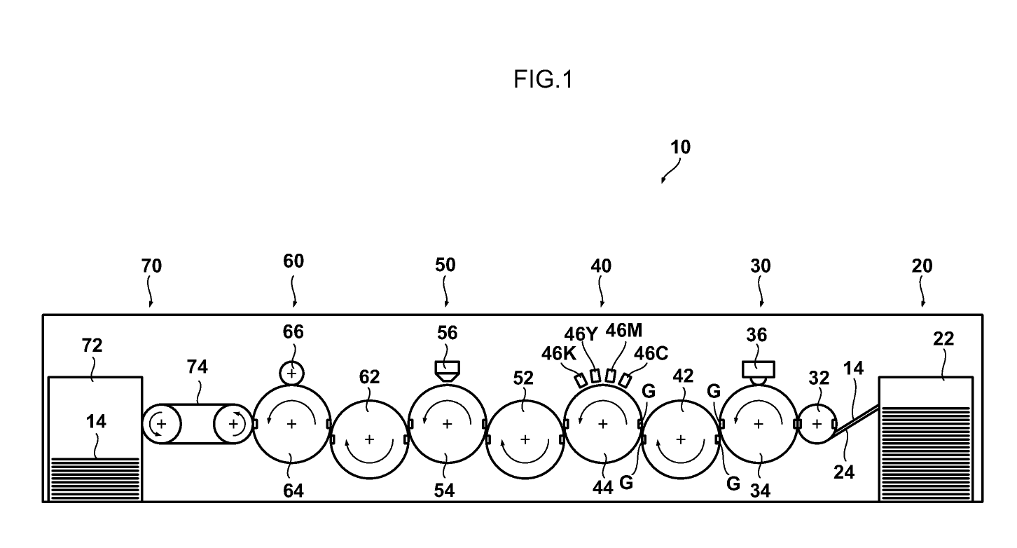

FIG. 1 is a diagram showing the entire configuration of an inkjet recording apparatus for printing an image on a sheet of paper by means of an inkjet method.

An inkjet recording apparatus 10 includes a paper supply unit 20 for supplying a sheet (piece of paper) 14, a treatment liquid application unit 30 for applying a predetermined treatment liquid to a print surface of the sheet 14, a rendering unit 40 for depositing ink droplets from an inkjet head onto the print surface of the sheet 14 to render an image, a dryer 50 for drying the ink deposited on the sheet 14, a fixing unit 60 for fixing the image rendered on the sheet 14, and a paper discharging unit 70 for discharging the sheet after printing it.

The treatment liquid application unit 30, the rendering unit 40, the dryer 50, and the fixing unit 60 are provided with impression cylinders (conveyance drums) 34, 44, 54 and 64 as conveyance devices, respectively. The sheet 14 is wrapped around the circumferential surfaces of these impression cylinders 34, 44, 54, 64 and conveyed in the treatment liquid application unit 30, rendering unit 40, dryer 50, and fixing unit 60 while rotating.

Transfer cylinders (conveyance drums) 32, 42, 52 and 62 serving as conveyance devices are disposed between the paper supply unit 20 and the treatment liquid application unit 30, between the treatment liquid application unit 30 and the rendering unit 40, between the rendering unit 40 and the dryer 50, as well as between the dryer 50 and the fixing unit 60. The sheet 14 is wrapped around the circumferential surfaces of these transfer cylinders 32, 42, 52, 62 and conveyed in each space between the units while rotating.

The impression cylinders 34, 44, 54, 64 and the transfer cylinders 32, 42, 52, 62 are disposed alternately and driven by motors that are not shown, to rotate in directions opposite to each other. In other words, the impression cylinders 34, 44, 54, 64 are rotated in a counterclockwise direction in FIG. 1, while the transfer cylinders 32, 42, 52, 62 are rotated in a clockwise direction in FIG. 1.

Note that the circumferential surfaces of the impression cylinders 34, 44, 54, 64 and the transfer cylinders 32, 42, 52, 62 are each provided with grippers G for gripping a leading end of the sheet 14. The sheet 14 is wrapped about each of the circumferential surfaces of the impression cylinders 34, 44, 54, 64 and of the transfer cylinders 32, 42, 52, 62 while being gripped by the grippers G at the leading end part of the sheet 14.

Note that the sheet 14 is wrapped around the circumferential surfaces of the impression cylinders 34, 44, 54, 64 with its image recording surface (i.e. print surface) on the outside, and is wrapped around the circumferential surfaces of the transfer cylinders 32, 42, 52, 62 with the rear surface (which is a surface opposite from the print surface) on the outside.

The sheet 14 that is supplied by the paper supply unit 20 is delivered to the impression cylinder 34 of the treatment liquid application unit 30 via the transfer cylinder 32, and is then delivered from the impression cylinder 34 of the treatment liquid application unit 30 to the impression cylinder 44 of the rendering unit 40 via the transfer cylinder 42. The sheet 14 is then delivered from the impression cylinder 44 of the rendering unit 40 to the impression cylinder 54 of the dryer 50 via the transfer cylinder 52, and is then delivered from the impression cylinder 54 of the dryer 50 to the impression cylinder 64 of the fixing unit 60 via the transfer cylinder 62. The sheet 14 is further transferred from the impression cylinder 64 of the fixing unit 60 to the paper discharging unit 70. In this series of conveyance processes, the sheet 14 passes through the treatment liquid application unit 30, the rendering unit 40, the dryer 50 and the fixing unit 60, is then subjected to a required process at each unit, and thereby an image is formed on the print surface (image recording surface).

The configuration of each of the units (the paper supply unit 20, the treatment liquid application unit 30, the rendering unit 40, the dryer 50, the fixing unit 60, and the paper discharging unit 70) of the inkjet recording apparatus 10 of the present embodiment is described hereinafter.

### Paper Supply Unit

The paper supply unit 20 has a paper supply apparatus 22 and a paper tray 24 for continuously supplying sheets (coated paper for printing, for example) 14 one by one.

The paper supply apparatus 22 supplies, to the paper tray 24, the sheets 14 that are stored in a stacked state in a stacker that is not shown, one by one sequentially from the top.

The paper tray 24 sends the sheets 14 that are sequentially supplied one by one from the paper supply apparatus 22, toward the transfer cylinder 32.

The sheets 14 that are sent out from the paper tray 24 are delivered to the impression cylinder 34 of the treatment liquid application unit 30 via the transfer cylinder 32.

Treatment liquid Application Unit

The treatment liquid application unit 30 applies a predetermined treatment liquid to the print surface of the sheet 14. The treatment liquid application unit 30 includes the impression cylinder (treatment liquid drum) 34 for conveying the sheet 14, and a treatment liquid application apparatus 36 for applying the predetermined treatment liquid to the print surface (image recording surface) of the sheet 14 conveyed by the treatment liquid drum 34.

The treatment liquid drum 34 receives the sheet 14 from the transfer cylinder 32 (by gripping the leading end of the sheet 14 using the grippers G), wraps the sheet 14 around the circumferential surface thereof, and rotates and conveys the sheet 14. In this mechanism, the treatment liquid drum 34 receives the sheet 14 from the transfer cylinder 32, with the print surface of the sheet 14 on the outside, and rotates and conveys the sheet 14.

The treatment liquid application apparatus 36 applies the predetermined treatment liquid to the print surface of the sheet 14 that is rotated and conveyed by the treatment liquid drum 34. The treatment liquid application apparatus 36 presses an application roller of which the circumferential surface is provided with the treatment liquid, so as to contact with the circumferential surface of the sheet 14, applying the treatment liquid to the print surface of the sheet 14.

Here, as the treatment liquid to be applied to the sheet 14, a liquid that functions to react with ink deposited by the rendering unit 40 so as to aggregate the color materials of the ink is used. When such treatment liquid is deposited in advance and the ink droplets are deposited to the sheet 14, the color materials of the ink droplets are aggregated immediately after the ink droplets land, and thus the color materials can be prevented from being mixed even when the ink droplets land adjacent to each other.

The treatment liquid application unit 30 is configured as described above. The print surface of the sheet 14 that is delivered from the transfer cylinder 32 to the treatment liquid drum 34 is given the treatment liquid by the treatment liquid application apparatus 36 in the course of being rotated and conveyed by the treatment liquid drum 34. Then, the sheet 14 applied with the treatment liquid is delivered from the treatment liquid drum 34 to the transfer cylinder 42 and then delivered from the transfer cylinder 42 to the impression cylinder 44 of the rendering unit 40.

### Rendering Unit

The rendering unit 40 deposits the ink droplets in C, M, Y, K colors to the print surface of the sheet 14, to form a color image on the print surface of the sheet 14. This rendering unit 40 includes the impression cylinder (recording drum) 44 for conveying the sheet 14, and inkjet heads 46C, 46M, 46Y, 46K for depositing the ink droplets in C, M, Y, K colors onto the sheet 14.

The recording drum 44 receives the sheet 14 from the transfer cylinder 42, wraps the sheet 14 around the circumferential surface thereof, and rotates and conveys the sheet 14. In this mechanism, the recording drum 44 receives the sheet 14 from the transfer cylinder 42, with the print surface of the sheet 14 on the outside, and rotates and conveys the sheet 14.

When receiving the sheet 14 from the treatment liquid drum 34 of the treatment liquid application unit 30, the transfer cylinder 42 receives the sheet 14 from the treatment liquid drum 34, with the other side (rear surface) opposite to the image recording surface (print surface) on the outside, and rotates and conveys the sheet 14.

The four inkjet heads 46C, 46M, 46Y, 46K, which are disposed around the recording drum 44 at regular intervals, eject the ink droplets in the corresponding colors toward the recording drum 44. The inkjet heads 46C, 46M, 46Y, 46K are configured by line heads corresponding to the width of the sheet. A row of nozzles having the length corresponding to the width of the sheet is formed on a surface (nozzle surface) of each inkjet head facing the recording drum 44, along a direction perpendicular to a conveyance direction of the sheet 14.

The configurations of the inkjet heads 46C, 46M, 46Y, 46K and the method for driving the same are described below in detail.

The rendering unit 40 is configured as described above. The sheet 14 that is delivered from the treatment liquid drum 34 to the recording drum 44 via the transfer cylinder 42 passes under the inkjet heads 46C, 46M, 46Y, 46K while being rotated and conveyed by the recording drum 44. The ink droplets in C, M, Y, K colors are deposited on the print surface by the inkjet heads 46C, 46M, 46Y, 46K during the passage of the sheet 14, whereby the color image is recorded on the print surface.

At this process, because the treatment liquid that has a function for aggregating the color materials of the ink is applied to the sheet 14 in advance, the color materials can be prevented from being mixed, so that a high quality image can be recorded.

Note in the present embodiment that a water-based ink having thermoplastic resins dispersed therein is used as the ink ejected from each of the inkjet heads 46C, 46M, 46Y and 46K.

The sheet 14, of which the ink droplets in C, M, Y, K colors from the inkjet heads 46C, 46M, 46Y, 46K has been ejected and thereby an image is recorded onto the print surface, is delivered from the recording drum 44 to the transfer cylinder 52, and then from the transfer cylinder 52 to the impression cylinder 54 of the dryer 50.

### Dryer

The dryer 50 dries the sheet 14 on which the image is recorded. The dryer 50 includes the impression cylinder (drying drum) 54 for conveying the sheet 14, and a drying apparatus 56 that performs a drying process on the sheet 14 conveyed by the drying drum 54.

The drying drum 54 receives the sheet 14 from the transfer cylinder 52, wraps the sheet 14 around the circumferential surface thereof, and rotates and conveys the sheet 14. In this mechanism, the drying drum 54 receives the sheet 14 from the transfer cylinder 52, with the print surface of the sheet 14 on the outside, and rotates and conveys the sheet 14. The drying apparatus 56 performs a process of evaporating the moisture present on the sheet. In other words, when the ink is deposited on the sheet 14 by the rendering unit 40, a liquid component of the ink and a liquid component of the treatment liquid that are separated by the aggregation reaction between the treatment liquid and the ink remain on the sheet, and therefore, the drying apparatus 56 performs the process of evaporating and removing the liquid components remaining on the sheet. This drying apparatus 56 evaporates and removes the liquid components present on the sheet, by blowing warm air to the sheet 14 conveyed by the drying drum 54.

The dryer 50 is configured as described above. The sheet 14 that is delivered from the recording drum 44 to the drying drum 54 via the transfer cylinder 52 is subjected to the drying process in which the warm air is blown from the drying apparatus 56 to the sheet 14 while the sheet 14 is conveyed by the drying drum 54. The sheet 14 that passes through the drying apparatus 56 is delivered from the drying drum 54 to the transfer cylinder 62 and conveyed to the fixing unit 60.

### Fixing Unit

The fixing unit 60 heats and pressurizes the sheet 14 to fix the image rendered to the print surface. This fixing unit 60 includes the impression cylinder (fixing drum) 64 for conveying the sheet 14, and a heat roller 66 for performing a heating/pressurizing process on the sheet 14 that is conveyed by the fixing drum 64.

The fixing drum 64 receives the sheet 14 from the transfer cylinder 62, wraps the sheet 14 around the circumferential surface thereof, and rotates and conveys the sheet 14. In this mechanism, the fixing drum 64 receives the sheet 14 from the transfer cylinder 62, with the print surface of the sheet 14 on the outside, and rotates and conveys the sheet 14.

The heat roller 66 heats and pressurizes the ink that is dried by the dryer 50, so as to weld the thermoplastic resins dispersed in the ink so that a film of the ink is formed. The heat roller 66 also straightens cockles formed on the sheet 14 at the same time. This heat roller 66 is formed so as to correspond to the width of the sheet and heated to a predetermined temperature by an embedded heat source (infrared heater, for example). A pressurizing device which is not shown presses the heat roller 66 toward the circumferential surface of the fixing drum 64, with a predetermined pressure.

The fixing unit 60 is configured as described above. The sheet 14 that is delivered from the transfer cylinder 62 to the fixing drum 64 is heated and pressurized as the heat roller 66 is pressed and brought into contact with the print surface of the sheet 14 while the sheet 14 is conveyed by the fixing drum 64. As a result, the thermoplastic resins dispersed in the ink are adhered (weld), forming the ink into a film. In addition, the cockles formed on the sheet 14 are straightened at the same time.

The sheet 14 that is heated and pressed by the heat roller 66 is delivered from the fixing drum 64 to the paper discharging unit 70.

### Paper Discharging Unit

The paper discharging unit 70 recovers the sheets 14 into a stacker 72 after a series of image recording steps are performed on the sheets 14. The paper discharging unit 70 has a conveyor 74 that conveys the sheets 14 to the stacker 72. The sheets 14 that are subjected to the fixing process by the fixing unit 60 are delivered from the fixing drum 64 to the conveyor 74. The sheets 14 are then conveyed by the conveyor 74, to the position where the stacker 72 is set. The stacker 72 is set at a predetermined recovery position, and the sheets 14 conveyed by the conveyor 74 are discharged into the stacker 72, sequentially stacked in the stacker 72, and recovered.

### Printing Operations

Next, printing operations performed the inkjet recording apparatus 10 are described.

The paper supply apparatus 22 supplies the sheets 14 stored in the stacker (not shown) one by one sequentially from the top to the paper tray 24. The sheets 14 that are supplied to the paper tray 24 are delivered to the treatment liquid drum 34 of the treatment liquid application unit 30 via the transfer cylinder 32. Then, the treatment liquid is applied by the treatment liquid application apparatus 36 to the surface of each of the sheets 14 while each of the sheets 14 is conveyed by the treatment liquid drum 34.

Each sheet 14 applied with the treatment liquid is delivered from the treatment liquid drum 34 to the rendering drum 44 of the rendering unit 40 via the transfer cylinder 42. The ink droplets in corresponding colors are deposited from the inkjet heads 46C, 46M, 46Y, 46K to the sheet 14 while the sheet 14 is conveyed by the rendering drum 44, whereby the image is formed on the print surface.

The sheet 14 having the image formed on the print surface thereof is delivered from the rendering drum 44 to the drying drum 54 of the dryer 50 via the transfer cylinder 52. The warm air is blown from the drying apparatus 56 to the sheet 14 while the sheet 14 is conveyed by the drying drum 54, whereby the ink deposited onto the print surface of the sheet 14 is dried.

The sheet 14 having the dried ink is delivered from the drying drum 54 to the fixing drum 64 via the transfer cylinder 62. Then, the heat roller 76 is pressed and brought into contact with the print surface of the sheet 14 while the sheet 14 is conveyed by the fixing drum 64, whereby the ink is heated and pressurized. As a result, the image formed on the print surface of the sheet 14 is fixed.

The sheet 14 having the image fixed thereto by the fixing unit 60 is delivered to the conveyor 74 of the paper discharging unit 70, conveyed to the stacker 72 by the conveyor 74, and then discharged into the stacker.

As described above, the printing is carried out through the series of steps where paper supply, treatment liquid application, image rendering, ink drying, image fixation, and paper discharge are performed in this order.

### Configurations of the Inkjet Heads

Next, the configurations of the inkjet heads 46C, 46M, 46Y, 46K in the above-described inkjet recording apparatus 10 are described.

Because the structures of the inkjet heads 46C, 46M, 46Y, 46K corresponding to the colors are all the same, reference numeral 100 is used to illustrate the representative inkjet head.

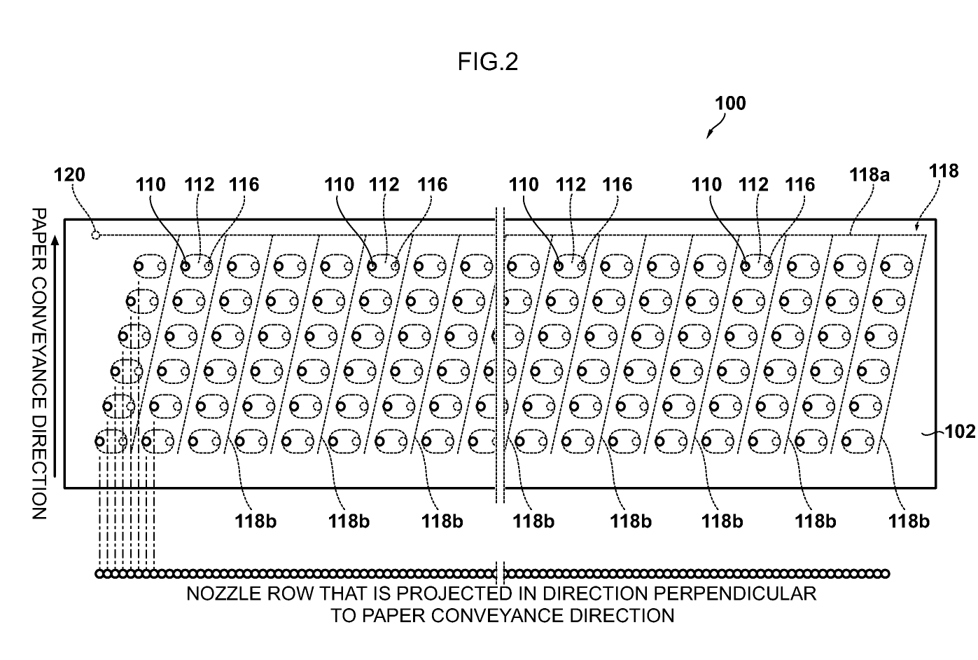

FIG. 2 is a plane perspective view of an ink ejection surface of an inkjet head 100.

As shown in FIG. 2, in the inkjet head 100 of the present embodiment, the nozzles 110 are disposed in a staggered manner on an ink ejection surface 102. In other words, the plurality of nozzles 110 are arrayed two-dimensionally at predetermined intervals in a longitudinal direction of the head (a first direction) and a direction that is inclined at a predetermined angle to the longitudinal direction (a second direction). By arraying the nozzles 110 in such a staggered manner, the substantial space between the nozzles that is projected in the longitudinal direction of the head (the direction perpendicular to the sheet conveyance direction) can be narrowed, and the density of the nozzles 110 can be increased.

The nozzles 110 are connected with respective pressure chambers 112 through nozzle flow paths 114. The pressure chambers 112 also are arrayed in a staggered manner on a surface parallel to the ink ejection surface 102 in the same manner as the nozzles 110.

As shown in FIG. 2, the planar shape of each pressure chamber 112 is formed into an oval, and the long axis (the axis in the longitudinal direction) thereof is disposed parallel to the longitudinal direction of the inkjet head 100. A nozzle flow path 114 and an individual supply flow path 116 are connected with each end of this pressure chamber 112 in the longitudinal direction thereof

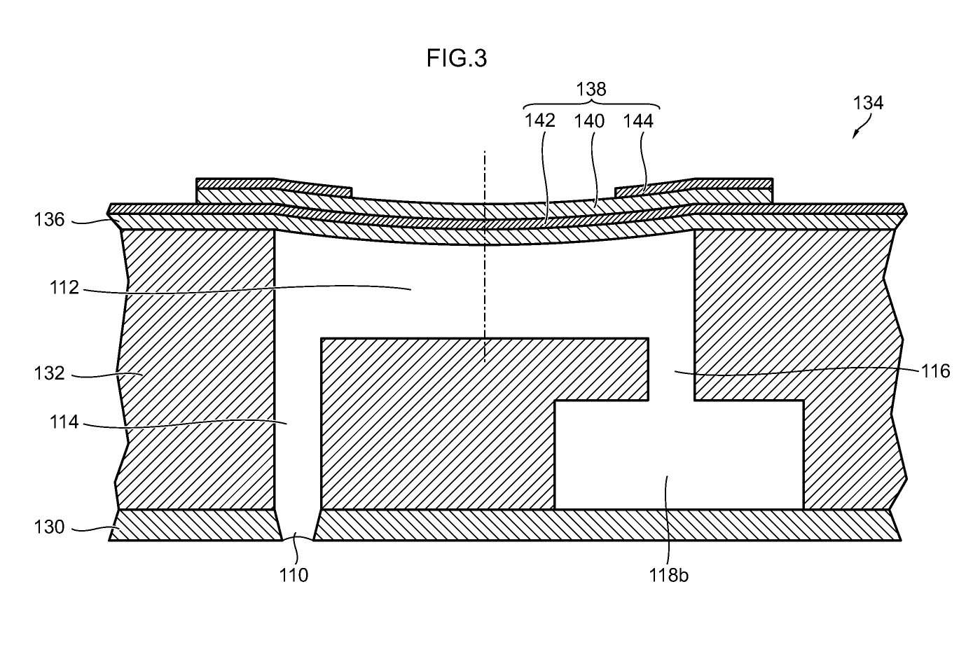

The nozzle flow paths 114 are formed to extend vertically downward from the pressure chambers 112 (see FIG. 3) and are connected with the nozzles 110 formed on the ink ejection surface 102.

Each individual supply flow path 116, on the other hand, is connected with a common supply flow path 118 that supplies the ink to each of the pressure chambers 112. As shown in FIG. 2, this common supply flow path 118 is configured by a main flow part 118a that extends in a direction parallel to the longitudinal direction of the inkjet head 100, and a plurality of branching flow parts 118b that branch from the main flow part 118a and extend in the second direction. The individual supply flow paths 116 that are connected with the pressure chambers 112 respectively are connected with the branching flow parts 118b respectively. The ink is supplied from an ink tank, not shown, to the ink supply port 120 formed on one end of the main flow part 118a. The ink that is supplied to the ink supply port 120 is then supplied from the main flow part 118a to each of the pressure chambers 112 via each branching flow part 118b and individual supply flow path 116.

FIG. 3 is a vertical cross-sectional diagram showing a part of the inkjet head 100.

As shown in the diagram, the inkjet head 100 of the present embodiment has a structure in which a nozzle plate 130, a flow path substrate 132, and a piezoelectric actuator 134 are stacked sequentially.

The nozzle plate 130 is a substrate in which the nozzles 110 are formed, and is joined to the flow path substrate 132 so as to cover the lower surface of the flow path substrate 132.

In the inkjet head 100 of the present embodiment, the nozzle plate 130 is made of silicon (Si) using a SOI (Silicon On Insulator) substrate. In so doing, first, the nozzles are formed in the SOI substrate by means of anisotropic etching or the like, and the SOI substrate having the nozzles formed therein is joined to the lower surface of the flow path substrate 132. Then, after joining the SOI substrate and the flow path substrate 132, the Si substrate and SiO₂ layer of the SOI substrate are removed. As a result, the nozzle plate 130 made of Si is formed on the lower surface of the flow path substrate 132. The flow path substrate 132 is a substrate in which the pressure chambers 112, the nozzle flow paths 114, the individual supply flow paths 116, the common supply flow path 118 and the like are formed. In the inkjet head 100 of the present embodiment, this flow path substrate 132 is formed from a Si substrate having a predetermined thickness. The pressure chambers and the like are formed by subjecting this Si substrate to etching processing or the like.

A piezoelectric actuator 134 is provided correspondingly to each of the pressure chambers 112 formed in the flow path substrate 132 and is configured mainly by a diaphragm 136 and a piezoelectric element 138 provided on the diaphragm 136.

The diaphragm 136 is joined to the flow path substrate 132 so as to cover an upper surface of the flow path substrate 132. A ceiling surface (one wall surface) of each pressure chamber 112 formed in the flow path substrate 132 is configured by joining the diaphragm 136 to the upper surface of the flow path substrate 132. In other words, an upper part of each pressure chamber 112 formed in the flow path substrate 132 is opened, and the diaphragm 136 is joined thereto so that the opened upper part is covered, whereby the ceiling surface is formed.

In the inkjet head 100 of the present embodiment, this diaphragm 136 is made of Si and formed using a SOI substrate. In so doing, the SOI substrate is joined to the upper surface of the flow path substrate 132 with the surface Si layer at the bottom. After joining the SOI substrate to the upper surface of the flow path substrate 132, the Si substrate and SiO₂ layer of the SOI substrate are removed. As a result, the diaphragm 136 made of Si is formed on the upper surface of the flow path substrate 132.

Furthermore, in the inkjet head 100 of the present embodiment, the diaphragm 136 is bent into a projecting shape protruding toward the pressure chamber 112 side in the region where the pressure chamber 112 is formed (the region where the ceiling surface of the pressure chamber 112 is formed), as shown in FIG. 3.

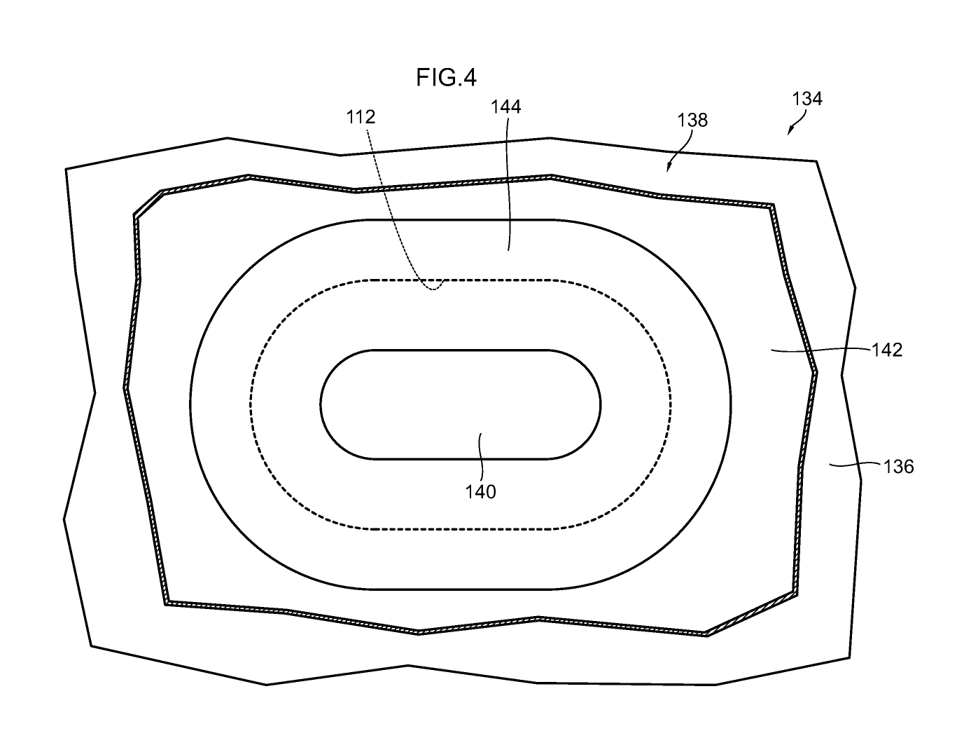

A piezoelectric element 138 is provided with respect to each of the pressure chambers 112 and disposed on the diaphragm 136 configuring the ceiling surface of each pressure chamber 112. Each piezoelectric element 138 is configured by a piezoelectric body 140, a lower electrode 142 serving as a common electrode, and an upper electrode 144 serving as an individual electrode, wherein the piezoelectric body 140 is sandwiched between the lower electrode 142 and the upper electrode 144. As shown in FIG. 4, the planar shape of the piezoelectric element 138 is formed into an oval to correspond to the planar shape (oval shape) of the pressure chamber 112, and is also bent into a projecting shape protruding toward the pressure chamber, as with the diaphragm 136.

The piezoelectric body 140 is formed into an oval to correspond to the planar shape of the pressure chamber 112, and disposed coaxially with the pressure chamber 112. This piezoelectric body 140 is formed to be larger than the external form of the pressure chamber 112 and disposed on the diaphragm such that an outer circumferential part of the piezoelectric body 140 projects from the rim part of the pressure chamber 112 by a predetermined distance.

This piezoelectric body 140 is made of a piezoelectric material with ferroelectricity, such as lead zirconium titanate (PZT) or other ceramic materials.

The lower electrode 142 is formed over the entire upper surface of the diaphragm 136. The piezoelectric body 140 is formed on an upper surface of this lower electrode 142.

This lower electrode 142 is made of a conductive material such as gold, silver, copper, palladium, platinum, and titanium and formed on the diaphragm 136 by means of a screen printing method, a sputtering method, an evaporation method, or the like.

The lower electrode 142 is connected to the ground through a flexible printed wiring (not shown).

On the other hand, an upper electrode 144 is formed into a circle on the upper surface of each piezoelectric body 140 so as to overlap with the rim part of each pressure chamber 112. The outer circumference of the upper electrode 144 is formed into an oval corresponding to the outer circumference of the piezoelectric body 140, and the inner circumference of the same is formed into a similar oval thereto. In other words, the upper electrode 144 is formed to cover the region other than the center of the pressure chamber 112.

The upper electrodes 144 are made of a conductive material, such as gold, silver, copper, palladium, platinum, and titanium, and formed on the piezoelectric body 140 individually by means of a screen printing method, a sputtering method, an evaporation method, or the like.

Each upper electrode 144 is connected to a drive circuit (not shown) via a flexible printed wiring (not shown), and a driving voltage is selectively applied to each upper electrode 144 via this driving circuit.

As described above, in the inkjet head 100 of the present embodiment, the piezoelectric actuator 134 is formed to be bent into a projecting shape protruding toward the pressure chamber in the initial state. The piezoelectric actuator 134 that is bent into a projecting shape protruding toward the pressure chamber in the initial state as described above can be formed as follows.

Specifically, when forming the piezoelectric body 140 on the diaphragm 136 made of Si via the lower electrode 142, a PZT film of the piezoelectric body 140 is formed by a thin film forming method (a sputtering method, sol-gel method, laser abrasion method, CDV method etc., for example), and a heat treatment is performed thereon during this formation process.

The coefficient of linear expansion of the PZT is greater than that of Si forming the base substrate and therefore generates a downward projecting shape of PZT. Consequently, in the initial state, the piezoelectric actuator 134 that is bent into a projecting shape protruding toward the pressure chamber can be formed. For example, the coefficient of linear expansion of Si is 2.6E-6/° C., and the coefficient of linear expansion of genuine PZT is 3.0E-6/° C. In this case, a PZT film is formed at 500° C. or 400° C., and when the temperature returns to a room temperature (25° C.), a structure that bends into a downward projecting shape by approximately 0.1 μm (0.08 μm) can be formed in the piezoelectric actuator having a width of 240 μm (where the thickness of the PZT is 2.5 μm and the thickness of the diaphragm is 11.5 μm). At this moment, when a voltage of 25 V is applied, the structure is displaced into a projecting shape protruding above by 137 nm (according to simulation performed by Ansys).

In the inkjet head 100 of the present embodiment, a thin film of the piezoelectric body 140 is formed on the Si diaphragm 136 via the lower electrode 142 therebetween, by means of a sputtering process involving a heat treatment.

### Operations of the Inkjet Head

The operations of the inkjet head 100 are described next.

In the inkjet head 100, the volume of each of the pressure chambers 112 is increased or reduced by individually applying a driving voltage to the upper electrode 144 of a piezoelectric actuator 134 provided correspondingly to each pressure chamber 112, and ink droplets are ejected from the nozzles 110 connected with the respective pressure chambers 112.

As described above, the drive circuit (not shown) applies the driving voltage to each piezoelectric actuator 134.

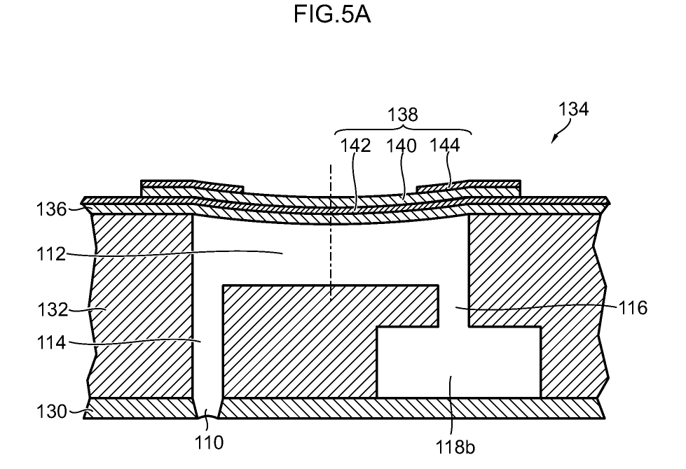

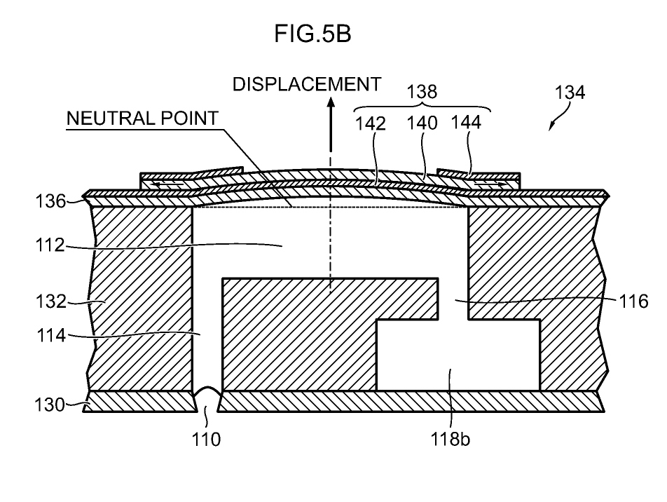

As shown in FIG. 5A, the piezoelectric actuator 134 is bent into a projecting shape protruding toward the pressure chamber in the initial state (in the state where the driving voltage is not applied).

When the driving voltage is applied from the drive circuit to the upper electrode 144 of the piezoelectric actuator 134, the circular region of the piezoelectric body 140 sandwiched between the circular upper electrode 144 and lower electrode 142 contracts in a direction (horizontal direction) perpendicular to a polarization direction (thickness direction of the piezoelectric body 140). As the circular region of the piezoelectric body 140 contracts in the direction perpendicular to the polarization direction, the diaphragm 136 passes beyond the neutral point with no deflection (a state with no vertical concave/convex shape) and deforms into a projecting shape protruding toward the side opposite to the pressure chamber 112 as shown in FIG. 5B.

In this case, because the piezoelectric actuator 134 is previously bent into a projecting shape protruding toward the pressure chamber, application of the driving voltage allows the piezoelectric actuator 134 to deform easily. In other words, because the piezoelectric body 140 receives a tensile stress by previously being bent into a projecting shape protruding toward the pressure chamber, applying the driving voltage and acting the tensile force allows the piezoelectric actuator 140 to deform easily using the buckling effect.

Then, by deforming the diaphragm 136 into a projecting shape protruding toward the side opposite to the pressure chamber, the volume of each pressure chamber 112 increases.

Thereafter, when the application of the driving voltage to the upper electrode 144 is stopped, the diaphragm 136 returns to its original shape (the projecting shape that is bent to protrude toward the pressure chambers side). Consequently, the volume of the pressure chamber 112 decreases, and the ink inside the pressure chamber is pushed out to the nozzle flow path 114, whereby an ink droplet is ejected from the nozzle 110.

In the inkjet head 100 of the present embodiment, the driving voltage is applied to the piezoelectric actuator 134 that is previously bent into a projecting shape protruding toward the pressure chamber, to displace the diaphragm 136 toward the side opposite to the pressure chamber. Then, the shape of the diaphragm 136 is returned to its original shape, and the ink is ejected. In this manner, a high displacement can be provided to the diaphragm 136 and a high ejection pressure can be accomplished. Moreover, a sufficient displacement can be obtained without thinning the film of the diaphragm 136 more than necessary or without forming the piezoelectric body 140 only in the area other than the region corresponding to the central section of the pressure chamber 112, thus the rigidity can be secured.

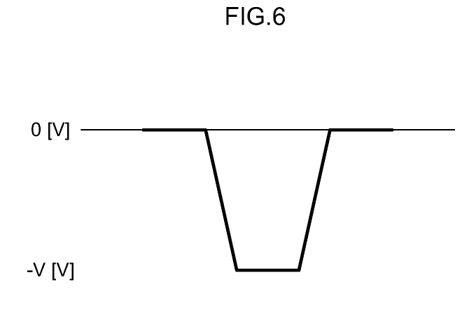

FIG. 6 is a diagram showing an example of a drive waveform of the driving voltage applied to a piezoelectric actuator 134.

Because the polarization direction of the film of the piezoelectric body (PZT) 140 that is formed by means of sputtering is opposite of the direction in which the piezoelectric body 140 is normally used, the potential of the lower electrode 142 serving as the common electrode is taken as 0 (V), and a negative potential (−V (V)) is applied to the upper electrode 144 serving as the individual electrode. According to the driving method used in this case, a voltage is applied in order to draw the ink, and the voltage is opened in order to eject the ink. By applying the driving voltage only when ejecting the ink, as described above, highly reliable drive of the inkjet head 100 can be achieved.

On the other hand, when the upper electrode 144 is formed into a circle, it is difficult to increase the generated pressure more than in the normal use because the voltage is opened to 0 (V) at the time of the ink ejection and therefore displacement is not applied forcibly. However, in the inkjet head 100 of the present embodiment described above, the piezoelectric actuator 134 is previously bent into a projecting shape protruding toward the pressure chamber, so that a high displacement can be secured and high ejection pressure can be obtained.

Note that the piezoelectric actuator 134 is configured to pass beyond the neutral point and to be displaced to the side opposite of the pressure chamber 112 side when applied with the driving voltage. Therefore, when the displacement with respect to the applied voltage is δL, the relationship thereof to an initial deflection amount δ0 (the amount of displacement from the neutral point during the initial state) is δL>δ0. The thickness of the diaphragm 136, the thickness of the piezoelectric body 140, and the applied voltage need to be designed in order to obtain a desired deflection amount δ0 and displacement amount δL, for this inequality.

The parameters for controlling the initial deflection amount include the coefficient of linear expansion of the piezoelectric body 140 (the coefficient of linear expansion can be increased by changing the additive amount of Nb (niobium)), the material (the coefficient of linear expansion) and thickness of the lower electrode 142. The piezoelectric actuator 134 is designed by combining these parameters.

Note in the embodiment described above that the diaphragm 136 is made of Si but the composition of the diaphragm 136 is not limited thereto. For example, metallic materials such as stainless steel, nickel, and aluminum can be used for forming the diaphragm 136.

On the other hand, as in the inkjet head 100 of the present embodiment explained above, the piezoelectric actuator 134 that is bent into a projecting shape protruding toward the pressure chamber can be formed easily by forming the diaphragm 136 with Si having a low coefficient of linear expansion and forming the piezoelectric body 140 by means of a thin film forming method involving a heat treatment.

Similarly, the flow path substrate 132 can be configured using a metallic material such as stainless steel, in place of Si or other silicon materials. In addition, the nozzle plate 130 can also be formed using a resin material such as polyimide or a metallic material such as stainless steel, in place of Si or other silicon materials.

As in the inkjet head 100 of the present embodiment described above, the flow paths and the like can be formed accurately and the density of the nozzles can be increased, by forming the nozzle plate 130, the flow path substrate 132, and the diaphragm 136 by using Si.

In the present embodiment, although the lower electrode 142 is formed over the entire upper surface of the diaphragm 136, the lower electrode 142 may be formed into an oval in accordance with the shape of the lower surface of the piezoelectric body 140 (oval shape).

Moreover, in the present embodiment, an example in which the present invention is applied to an inkjet head is described, but the application of the present invention is not limited to this embodiment. The present invention can be applied to a variety of liquid ejection heads that eject a conductive paste to form fine wiring patterns on a substrate, eject an organic light emitting material onto a substrate to form a high-definition display, or eject optical resin onto a substrate to form a minute electronic device such as an optical waveguide.

The shape of an individual electrode is not limited to a circular shape, and may be another shape such as a polygonal shape.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A liquid ejection head comprising a piezoelectric actuator that changes volume of a pressure chamber to cause liquid in the pressure chamber to eject from a nozzle connected with the pressure chamber,
wherein the piezoelectric actuator is formed into a projecting shape protruding toward the pressure chamber, and displaced in a direction opposite to the pressure chamber when applied with a driving voltage, to increase the volume of the pressure chamber.

2. The liquid ejection head as defined in claim 1, wherein the piezoelectric actuator passes beyond a neutral point with no deflection and deforms into a projecting shape protruding toward the direction opposite to the pressure chamber, when applied with the driving voltage.

3. The liquid ejection head as defined in claim 1, wherein the piezoelectric actuator includes:
a diaphragm which forms a wall surface of the pressure chamber;
a piezoelectric body which is disposed on a surface of the diaphragm opposite from the pressure chamber;
an individual electrode which is disposed on one surface of the piezoelectric body and in a region where the individual electrode overlaps with a rim part of the pressure chamber; and
a common electrode which is disposed on another surface of the piezoelectric body.

4. The liquid ejection head as defined in claim 3, wherein the piezoelectric actuator is formed into the projecting shape protruding toward the pressure chamber by forming the piezoelectric body on the diaphragm having a coefficient of linear expansion lower than that of the piezoelectric body, according to a thin film forming method involving a heat treatment.

5. The liquid ejection head as defined in claim 3, wherein the piezoelectric body contains Nb, and a coefficient of linear expansion of the piezoelectric body is made higher than that of the diaphragm by adjusting an additive amount of the Nb contained in the piezoelectric body.

6. The liquid ejection head as defined in claim 3, wherein the diaphragm is made of silicon.

7. The liquid ejection head as defined in claim 1, wherein the pressure chamber is formed in a silicon substrate.

8. The liquid ejection head as defined in claim 1, wherein the pressure chamber and the nozzle are provided in plurality, respectively, in such a manner that the pressure chambers are arrayed in a staggered manner in a substrate, and the nozzles are arrayed in a staggered manner in a nozzle surface.

9. The liquid ejection head as defined in claim 1, further comprising a control device which controls application of the driving voltage to the piezoelectric actuator to adjust ejection of a liquid droplet from the nozzle in such a manner that the driving voltage is applied to the piezoelectric actuator only when the liquid droplet is ejected from the nozzle.

10. The liquid ejection head as defined in claim 3, wherein the piezoelectric body is polarized in terms of a thickness direction of the piezoelectric body, and contracts in a direction perpendicular to the thickness direction when the driving voltage is applied to the piezoelectric body.

11. The liquid ejection head as defined in claim 3, wherein the individual electrode has an outer circumference corresponding to an outer circumference of the piezoelectric body, and has an inner circumference similar to the outer circumference of the individual electrode.

12. A method of manufacturing a liquid ejection head comprising a piezoelectric body disposed on a diaphragm forming a wall surface of a pressure chamber,
the method comprising the step of forming the piezoelectric body on the diaphragm having a coefficient of linear expansion lower than that of the piezoelectric body, according to a thin film forming method involving a heat treatment, in such a manner that the piezoelectric body and the diaphragm are bent into a projecting shape protruding toward the pressure chamber.

13. The method of manufacturing a liquid ejection head as defined in claim 12, further comprising the step of forming an individual electrode in a region where the individual electrode overlaps with a rim part of the pressure chamber.

14. The method of manufacturing a liquid ejection head as defined in claim 12, wherein the diaphragm is made of silicon.

15. The method of manufacturing a liquid ejection head as defined in claim 12, wherein the pressure chamber is formed in a silicon substrate.

16. The method of manufacturing a liquid ejection head as defined in claim 12, wherein an additive of Nb is adjusted to control the coefficient of linear expansion of the piezoelectric body.

17. The method of manufacturing a liquid ejection head as defined in claim 12, wherein the piezoelectric body is polarized in terms of a thickness direction of the piezoelectric body, and contracts in a direction perpendicular to the thickness direction when a driving voltage is applied to the piezoelectric body.

18. The method of manufacturing a liquid ejection head as defined in claim 13, wherein the individual electrode has an outer circumference corresponding to an outer circumference of the piezoelectric body, and has an inner circumference similar to the outer circumference of the individual electrode.

19. An image recording apparatus comprising the liquid ejection head defined in claim 1.

20. A method of driving the liquid ejection head defined in claim 1, comprising the step of applying the driving voltage to the piezoelectric actuator only when a liquid droplet is ejected from the nozzle.
